(19) United States
(12) Patent Application Publication
(10) Pub. No.: US 2024/0109090 A1
(43) Pub. Date: Apr. 4, 2024

(54) Single-material All-plastic Pump and Storage Bottle Applied Thereby

(71) Applicant: Guangzhou Shanggong Plastic Co., Ltd., Guangzhou (CN)

(72) Inventor: Qi Quan LIANG, Guangzhou (CN)

(21) Appl. No.: 17/938,960

(22) Filed: Sep. 7, 2022

(51) Int. Cl. B05B 11/10

(52) U.S. Cl. CPC B05B 11/1077; B05B 11/1026; B05B 11/1045; B05B 11/1069

(57) ABSTRACT

Disclosed are a single-material all-plastic pump and a storage bottle applied thereby, mainly including a plastic pressing head, a plastic pump casing, a plastic piston mechanism and a plastic reset spring; the plastic pressing head is in a pressable connection with the plastic pump casing, and has a discharge hole which is connected and communicated with a discharge end of the plastic piston mechanism; the plastic piston mechanism is disposed inside the plastic pressing head and the plastic pump casing, has a feed end which is connected and communicated with a material guide hose, and is used to control the opening and closing of the discharge hole and the material guide hose; the plastic reset spring is sleeved outside the plastic piston mechanism and compressed between the plastic pressing head and the plastic pump casing; and therefore, materials used in the solution are generally plastic, soft rubber, etc.

### TECHNICAL FIELD

The disclosure herein relates to the technical field related to plastic pump heads, in particular to a single-material all-plastic pump and a storage bottle applied thereby.

### BACKGROUND

Components of the existing pump heads are made of different materials, some of the components are plastic parts, and some of the components are metal parts, which will lead to a huge recovery cost of the pump heads; and because the plastic parts and the metal parts need to be classified for recovery when the pump heads are recovered, the pump heads must be disassembled manually, which is time-consuming and laborious, and seriously restricts the classification and recovery of the pump heads.

### SUMMARY

It is an object of the present disclosure to provide a single-material all-plastic pump and a storage bottle applied thereby to solve the problem that the existing pump heads are difficult to recycle.

In order to solve the technical problem, the present disclosure provides a single-material all-plastic pump, including a plastic pressing head, a plastic pump casing, a plastic piston mechanism and a plastic reset spring; the plastic pressing head is inserted into the plastic pump casing in a pressable manner, and is provided with a discharge hole which is connected and communicated with a discharge end of the plastic piston mechanism; the plastic piston mechanism is disposed inside the plastic pressing head and the plastic pump casing, has a feed end which is connected and communicated with a material guide hose, and is used to control the opening and closing of the discharge hole and the material guide hose; and the plastic reset spring is sleeved outside the plastic piston mechanism and compressed between the plastic pressing head and the plastic pump casing.

In one embodiment, a ring of pressing head guide slot is provided at a port of the plastic pump casing, and the plastic pressing head is slidably inserted into the pressing head guide slot.

In one embodiment, a feed delivery tube is disposed inside the plastic pressing head, and is connected and communicated with the discharge hole; the plastic pump casing is internally provided with a first cavity, a second cavity and a guide hole, wherein the guide hole communicates the first cavity and the second cavity, and the first cavity is internally provided with the plastic reset spring; and the discharge end of the plastic piston mechanism is connected and communicated with the feed delivery tube, the plastic piston mechanism is movably inserted into the guide hole, and the feed end of the plastic piston mechanism passes through the second cavity, and is connected and communicated with the material guide hose.

In one embodiment, the plastic piston mechanism includes a piston cylinder casing, a pumping unit and a sleeve; the piston cylinder casing is disposed in the second cavity and has a structure with an opening at each of both ends, the guide hole is externally surrounded by one port of the piston cylinder casing, and the other port thereof is connected and communicated with the material guide hose; the pumping unit is installed in the piston cylinder casing in a manner of allowing piston movement; and the sleeve is movably inserted into the guide hole, the plastic reset spring is sleeved outside the sleeve, one end of the sleeve is in a fixedly sleeved connection with the feed delivery tube and also communicated therewith, the other end of the sleeve passes through the guide hole, and is in a sleeved connection with the pumping unit and also communicated therewith, and the movement of the sleeve is used to control the pumping unit to open and close the discharge hole and the material guide hose.

In one embodiment, the pumping unit includes a pumping piston and a pumping tube; the pumping piston is installed in the piston cylinder casing in a manner of allowing piston movement, a positioning tube is disposed on the pumping piston and penetrates the pumping piston, and the positioning tube is in a movably sleeved connection with the inside of the sleeve; the pumping tube is movably inserted into the positioning tube, one end of the pumping tube is in a fixedly sleeved connection with the inside of the sleeve, the other end thereof is closed to form a stop block, the stop block occludes a port of the positioning tube in a sealing manner, and a pumping hole is reserved in a peripheral wall, adjacent to the stop block, of the pumping tube, and communicates the inside and outside of the pumping tube; and the pressing of the plastic pressing head is used to control the pumping hole to move into the piston cylinder casing.

In one embodiment, a casing wall of the piston cylinder casing is provided with an air return hole, and the air return hole communicates the inside and outside of the piston cylinder casing and is provided at a side, adjacent to the guide hole, of the piston cylinder casing; and the pumping piston in an initial position covers the air return hole.

In one embodiment, the piston cylinder casing is internally provided with a one-way valve, and the one-way valve includes a rubber ring, an elastic rubber film and soft rubber connecting ribs; the elastic rubber film is disposed in the rubber ring; the elastic rubber film shields a connected communication part of the material guide hose and the piston cylinder casing; and the plurality of soft rubber connecting ribs are connected between an inner peripheral wall of the rubber ring and an outer peripheral edge of the elastic rubber film.

In one embodiment, a gasket is sleeved outside the piston cylinder casing.

In one embodiment, the plastic reset spring is tubular.

In order to solve the technical problem, the present disclosure also provides a single-material storage bottle, wherein the storage bottle is equipped with the all-plastic pump, and the material guide hose is placed in the storage bottle. The present disclosure has the beneficial effects that:

Since the single-material all-plastic pump disclosed herein includes the plastic pressing head, the plastic pump casing, the plastic piston mechanism and the plastic reset spring, the materials of the entire pump are generally plastic, soft rubber, etc., and for example, the plastic reset spring completely replaces the existing metal spring, that is, the all-plastic pump can be directly recycled without disassembly during recycling, which greatly improves recycling efficiency and lowers recycling cost, thus effectively solving the problem that the existing pump heads are difficult to recycle.

### BRIEF DESCRIPTION OF FIGURES

In order to illustrate the technical solutions of the present disclosure more clearly, the following will briefly introduce the accompanying drawings used in the implementations. The drawings in the following description are only some implementations of the present disclosure, and it will be apparent to those skilled in the art, other drawings can also be obtained based on these drawings without any creative work.

FIG. 1 is a schematic diagram of a section view structure of an all-plastic pump provided by an embodiment of the present disclosure;

FIG. 2 is a schematic diagram of an exploded structure of FIG. 1;

FIG. 3 is a schematic diagram of a local enlarged structure of FIG. 1;

FIG. 4 is a schematic diagram of a pressed structure of FIG. 3;

FIG. 5 is a schematic diagram of a structure of a one-way valve of FIG. 1; and

FIG. 6 is a schematic diagram of a section view structure of a storage bottle provided by an embodiment of the present disclosure.

Reference numerals on the drawings are described below:
10 denotes a plastic pressing head; 11 denotes a discharge hole; 12 denotes a feed delivery tube;
20 denotes a plastic pump casing; 21 denotes a pressing head guide slot; 221 denotes a first cavity; 222 denotes a second cavity; 23 denotes a guide hole;
30 denotes a plastic piston mechanism; 31 denotes a piston cylinder casing; 311 denotes an air return hole; 32 denotes a pumping unit; 321 denotes a pumping piston; 322 denotes a pumping tube; 323 denotes a positioning tube; 324 denotes a stop block; 325 denotes a pumping hole; 33 denotes a sleeve;
40 denotes a plastic reset spring;
50 denotes a material guide hose;
60 denotes a one-way valve; 61 denotes a rubber ring; 62 denotes an elastic rubber film; 63 denotes soft rubber connecting ribs;
70 denotes a gasket; and
80 denotes a storage bottle.

### DETAILED DESCRIPTION

The technical solutions in the implementations of the present disclosure will be clearly and completely described below with reference to the accompanying drawings in the implementations of the present disclosure.

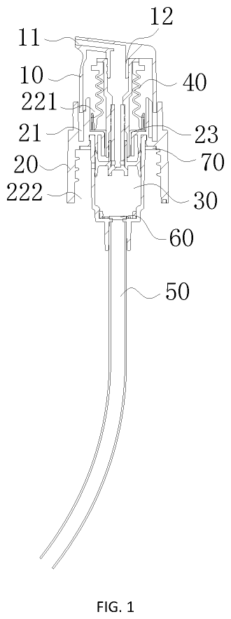

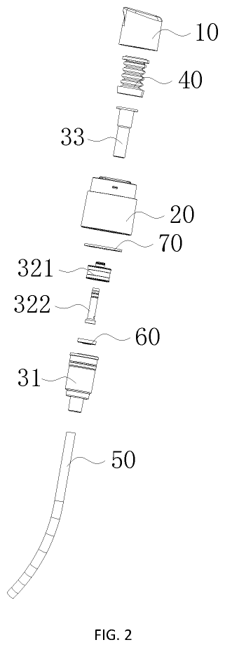

The present disclosure provides a single-material all-plastic pump, the embodiments of which are shown in FIGS. 1 to 4; the single-material all-plastic pump includes a plastic pressing head 10, a plastic pump casing 20, a plastic piston mechanism 30 and a plastic reset spring 40; the plastic pressing head 10 is inserted into the plastic pump casing 20 in a pressable manner, the plastic pressing head 10 is provided with a discharge hole 11, and the discharge hole 11 is connected and communicated with a discharge end of the plastic piston mechanism 30; the plastic piston mechanism 30 is disposed inside the plastic pressing head 10 and the plastic pump casing 20, the plastic piston mechanism 30 has a feed end which is connected and communicated with a material guide hose 50, and the plastic piston mechanism 30 is used to control the opening and closing of the discharge hole 11 and the material guide hose 50; and the plastic reset spring 40 is sleeved outside the plastic piston mechanism 30, and the plastic reset spring 40 compressed between the plastic pressing head 10 and the plastic pump casing 20.

When pressing is not performed, the plastic piston mechanism 30 is in a closed state, so that the communication between the discharge hole 11 and the material guide hose 50 will be cut off, and discharging cannot be realized accordingly; after being pressed, the plastic pressing head 10 will move to the inside of the plastic pump casing 20, and control the plastic piston mechanism 30 to become an open state, so as to communicate the discharge hole 11 and the material guide hose 50, thus realizing the discharging operation; and after the pressing of the plastic pressing head 10 is canceled, the plastic reset spring 40 will push the plastic pressing head 10 to reset automatically.

To sum up, since the single-material all-plastic pump disclosed herein includes the plastic pressing head 10, the plastic pump casing 20, the plastic piston mechanism 30 and the plastic reset spring 40, the materials of the entire pump are generally plastic, soft rubber, etc., and for example, the plastic reset spring 40 completely replaces the existing metal spring, that is, the all-plastic pump can be directly recycled without disassembly during recycling, which greatly improves recycling efficiency and lowers recycling cost, thus effectively solving the problem that the existing pump heads are difficult to recycle.

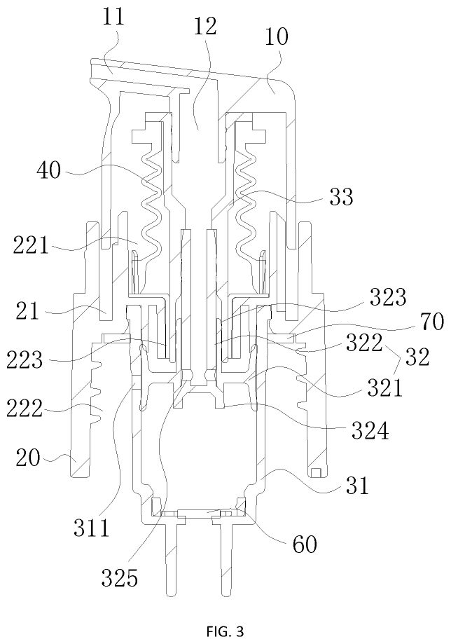

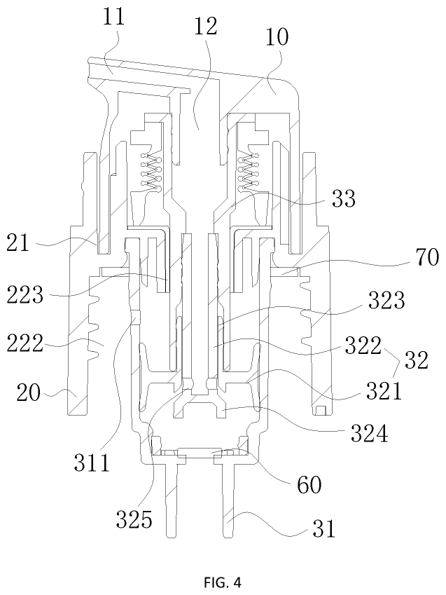

As shown in FIG. 1, FIG. 3, and FIG. 4, a ring of pressing head guide slot 21 is provided at a port of the plastic pump casing 20, and the plastic pressing head 10 is slidably inserted into the pressing head guide slot 21.

After the arrangement is adopted, the pressing head guide slot 21 substantially defines the movement trajectory of the plastic pressing head 10, thus allowing the plastic pressing head 10 to move up and down only in a direction shown in the drawings, which ensures that the plastic pressing head 10 will not be displaced during the operation, and provides a better use experience for the whole pressing operation process.

As shown in FIG. 1, FIG. 3, and FIG. 4, according to the embodiment, preferentially, a feed delivery tube 12 is disposed inside the plastic pressing head 10, and the feed delivery tube 12 is connected and communicated with the discharge hole 11; the plastic pump casing 20 is internally provided with a first cavity 221, a second cavity 222 and a guide hole 23, wherein the guide hole 23 communicates the first cavity 221 and the second cavity 222, and the first cavity 221 is internally provided with the plastic reset spring 40; and the discharge end of the plastic piston mechanism 30 is connected and communicated with the feed delivery tube 12, the plastic piston mechanism 30 is movably inserted into the guide hole 23, and the feed end of the plastic piston mechanism 30 passes through the second cavity 222, and is connected and communicated with the material guide hose 50. After the arrangement is adopted, if the plastic pressing head 10 is pressed, the plastic piston mechanism 30 can be driven to move in the guide hole 23, so that the opening and closing states of the plastic piston mechanism 30 are controlled.

Specifically, according to the embodiment, an open-close control structure of the plastic piston mechanism 30 is shown in FIG. 1, FIG. 3 and FIG. 4, and at this point, the plastic piston mechanism 30 includes a piston cylinder casing 31, a pumping unit 32 and a sleeve 33; the piston cylinder casing 31 is disposed in the second cavity 222, the piston cylinder casing 31 has a structure with an opening at each of both ends, the guide hole 23 is externally surrounded by one port of the piston cylinder casing 31, and the other port of the piston cylinder casing 31 is connected and communicated with the material guide hose 50; the pumping unit 32 is installed in the piston cylinder casing 31 in a manner of allowing piston movement; and the sleeve 33 is movably inserted into the guide hole 23, the plastic reset spring 40 is sleeved outside the sleeve 33, one end of the sleeve 33 is in a fixedly sleeved connection with the feed delivery tube 12 and also communicated therewith, the other end of the sleeve 33 passes through the guide hole 23, and is in a sleeved connection with the pumping unit 32 and also communicated therewith, and the movement of the sleeve 33 is used to control the pumping unit 32 to open and close the discharge hole 11 and the material guide hose 50.

When the pressing operation is not performed, the pumping unit 32 is placed above the piston cylinder casing 31, and the pumping unit 32 is in a non-communicating state, that is, the discharge hole 11 and the material guide hose 50 are not communicated to each other; and after the pressing operation is completed, the sleeve 33 will drive the pumping unit 32 to move down, and allow the pumping unit 32 to turn into a communicating state, that is, the communication between the discharge hole 11 and the material guide hose 50 is realized.

Specifically, according to the embodiment, an opening and closing control structure of the pumping unit 32 is shown in FIG. 1, FIG. 3 and FIG. 4, and at this point, the pumping unit 32 includes a pumping piston 321 and a pumping tube 322; the pumping piston 321 is installed in the piston cylinder casing 31 in a manner of allowing piston movement, a positioning tube 323 is disposed on the pumping piston 321, the positioning tube 323 penetrates the pumping piston 321, and the positioning tube 323 is in a movably sleeved connection with the inside of the sleeve 33; the pumping tube 322 is movably inserted into the positioning tube 323, one end of the pumping tube 322 is in a fixedly sleeved connection with the inside of the sleeve 33, the other end of the pumping tube 322 is closed to form a stop block 324, the stop block 324 occludes a port of the positioning tube 323 in a sealing manner, and a pumping hole 325 is reserved in a peripheral wall, adjacent to the stop block 324, of the pumping tube 322, and the pumping hole 325 communicates the inside and outside of the pumping tube 322; and the pressing of the plastic pressing head 10 is used to control the pumping hole 325 to move into the piston cylinder casing 31.

As shown in FIG. 3, the pressing operation is not performed at this time, so that the pumping hole 325 will be placed in a space enclosed by the positioning tube 323, and thus the all-plastic pump cannot realize discharging; as shown in FIG. 3, when the pressing operation is not performed, a lower end face of the sleeve 33 and the pumping piston 321 are separated from each other, so that the sleeve 33 has a certain downward movement space during the pressing operation; and therefore, shown in FIG. 4, after the pressing operation is completed, the pumping hole 325 will move down to the outside of the space enclosed by the positioning tube 323, and then a lower end of the sleeve 33 will be abutted with the pumping piston 321, thereby pushing the pumping piston 321 to move down, which allows the material in the piston cylinder casing 31 to be output after flowing through the pumping hole 325.

As shown in FIG. 3 and FIG. 4, according to the embodiment, preferentially, a casing wall of the piston cylinder casing 31 is provided with an air return hole 311, the air return hole 311 communicates the inside and outside of the piston cylinder casing 31, and the air return hole 311 is provided at a side, adjacent to the guide hole 23, of the piston cylinder casing 31; and the pumping piston 321 in an initial position covers the air return hole 311.

After the arrangement is adopted, pressure difference balance adjustment and control in the piston cylinder casing 31 can be realized by using the air return hole 311, so as to ensure that all components can be automatically and quickly reset to original positions after the pressing operation is completed.

As shown in FIGS. 3 to 5, according to the embodiment, preferentially, the piston cylinder casing 31 is internally provided with a one-way valve 60, and the one-way valve 60 includes a rubber ring 61, an elastic rubber film 62 and soft rubber connecting ribs 63; the elastic rubber film 62 is disposed in the rubber ring 61; the elastic rubber film 62 shields a connected communication part of the material guide hose 50 and the piston cylinder casing 31; and the plurality of soft rubber connecting ribs 63 are connected between an inner peripheral wall of the rubber ring 61 and an outer peripheral edge of the elastic rubber film 62.

When a pressure difference does not change, the elastic rubber film 62 will completely shield the connected communication part of the material guide hose 50 and the piston cylinder casing 31, so that a material cannot enter the piston cylinder casing 31; after the pressure difference in the piston cylinder casing 31 changes due to the pressing operation, the elastic rubber film 62 will deform, so as to release the shielding at the connected communication part of the material guide hose 50 and the piston cylinder casing 31; and therefore, the material can enter the piston cylinder casing 31, and one-way input of the material is accordingly realized.

As shown in FIG. 3 and FIG. 4, according to the embodiment, preferentially, a gasket 70 is sleeved outside the piston cylinder casing 31.

After the arrangement is adopted, the gasket 70 can be used to enhance the sealing performance of the all-plastic pump after assembly in the future.

As shown in FIGS. 1 to 4, according to the embodiment, preferentially, the plastic reset spring 40 is tubular.

After the arrangement is adopted, the spring made of plastic can also have a better deformation recovery ability.

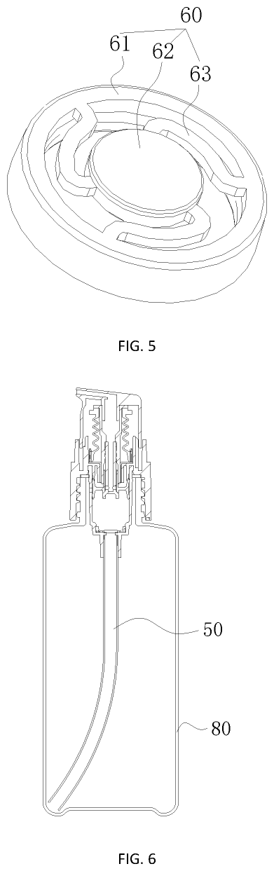

Of course, the above-mentioned all-plastic pump will be combined with the storage bottle for use in an actual application process, so that the present disclosure also provides the single-material storage bottle; and as shown in FIG. 6, the storage bottle 80 is equipped with the all-plastic pump, and the material guide hose 50 is placed in the storage bottle 80, which has the same functions as the above, and thus will not be described.

The above mentioned is the preferred implementation of the present disclosure. It should be pointed out that for those skilled in the art, many other improvements or modifications can be made without departing from the principle of the present disclosure, and these improvements and modifications are also recognized as the protection scope of the present disclosure.

What is claimed is:

1. A single-material all-plastic pump, comprising:
a plastic pressing head, a plastic pump casing, a plastic piston mechanism and a plastic reset spring;
the plastic pressing head is inserted into the plastic pump casing in a pressable manner, and is provided with a discharge hole which is connected and communicated with a discharge end of the plastic piston mechanism;
the plastic piston mechanism is disposed inside the plastic pressing head and the plastic pump casing, a feed end of the plastic piston mechanism is connected and communicated with a material guide hose, and the plastic piston mechanism is used to control the opening and closing of the discharge hole and the material guide hose; and
the plastic reset spring is sleeved outside the plastic piston mechanism, and is compressed between the plastic pressing head and the plastic pump casing.

2. The all-plastic pump according to claim 1, wherein a ring of pressing head guide slot is provided at a port of the plastic pump casing, and the plastic pressing head is slidably inserted into the pressing head guide slot.

3. The all-plastic pump according to claim 1, wherein
a feed delivery tube is disposed inside the plastic pressing head, and is connected and communicated with the discharge hole;
the plastic pump casing is internally provided with a first cavity, a second cavity and a guide hole, wherein the guide hole communicates the first cavity and the second cavity, and the first cavity is internally provided with the plastic reset spring; and
the discharge end of the plastic piston mechanism is connected and communicated with the feed delivery tube, the plastic piston mechanism is movably inserted into the guide hole, and the feed end of the plastic piston mechanism passes through the second cavity, and is connected and communicated with the material guide hose.

4. The all-plastic pump according to claim 3, wherein
the plastic piston mechanism includes a piston cylinder casing, a pumping unit and a sleeve;
the piston cylinder casing is disposed in the second cavity and has a structure with an opening at each of both ends, the guide hole is externally surrounded by one port of the piston cylinder casing, and the other port thereof is connected and communicated with the material guide hose;
the pumping unit is installed in the piston cylinder casing in a manner of allowing piston movement; and
the sleeve is movably inserted into the guide hole, the plastic reset spring is sleeved outside the sleeve, one end of the sleeve is in a fixedly sleeved connection with the feed delivery tube and also communicated therewith, the other end of the sleeve passes through the guide hole, and is in a sleeved connection with the pumping unit and also communicated therewith, and the movement of the sleeve is used to control the pumping unit to open and close the discharge hole and the material guide hose.

5. The all-plastic pump according to claim 4, wherein
the pumping unit comprises a pumping piston and a pumping tube;
the pumping piston is installed in the piston cylinder casing in a manner of allowing piston movement, a positioning tube is disposed on the pumping piston and penetrates the pumping piston, and the positioning tube is in a movably sleeved connection with the inside of the sleeve;
the pumping tube is movably inserted into the positioning tube, one end of the pumping tube is in a fixedly sleeved connection with the inside of the sleeve, the other end thereof is closed to form a stop block, the stop block occludes a port of the positioning tube in a sealing manner, and a pumping hole is reserved in a peripheral wall, adjacent to the stop block, of the pumping tube, and communicates the inside and outside of the pumping tube; and
the pressing of the plastic pressing head is used to control the pumping hole to move into the piston cylinder casing.

6. The all-plastic pump according to claim 5, wherein
a casing wall of the piston cylinder casing is provided with an air return hole, and the air return hole communicates the inside and outside of the piston cylinder casing and is provided at a side, adjacent to the guide hole, of the piston cylinder casing; and
the pumping piston in an initial position covers the air return hole.

7. The all-plastic pump according to claim 4, wherein
the piston cylinder casing is internally provided with a one-way valve, and the one-way valve comprises a rubber ring, an elastic rubber film and soft rubber connecting ribs;
the elastic rubber film is disposed in the rubber ring;
the elastic rubber film shields a connected communication part of the material guide hose and the piston cylinder casing; and
the plurality of soft rubber connecting ribs are connected between an inner peripheral wall of the rubber ring and an outer peripheral edge of the elastic rubber film.

8. The all-plastic pump according to claim 4, wherein a gasket is sleeved outside the piston cylinder casing.

9. The all-plastic pump according to claim 1, wherein the plastic reset spring is tubular.

10. A single-material storage bottle, wherein the storage bottle is equipped with the all-plastic pump according to claim 1, and the material guide hose is placed in the storage bottle.
